(19) United States
(12) Patent Application Publication
(10) Pub. No.: US 2007/0121228 A1
(43) Pub. Date: May 31, 2007

(54) Mirror glass component including an integrated luminescent film

(76) Inventor: Roland Oehmann, Stuttgart (DE)

Correspondence Address: CLARK HILL, P.C., 500 WOODWARD AVENUE, SUITE 3500, DETROIT, MI, 48226, US

(21) Appl. No.: 10/577,278

(22) PCT Filed: Oct. 21, 2004
(86) PCT No.: PCT/DE04/02351

§ 371 Date: Apr. 24, 2006

(30) Foreign Application Priority Data
Oct. 23, 2003 (DE) 103 49 742.0

(51) Int. Cl. G02B 27/14

(52) U.S. Cl. 359/839

(57) ABSTRACT

A vehicular external mirror module includes a mirror housing. A mirror glass is housed within the mirror housing. The mirror glass includes a non-mirrored surface facing out of the mirror housing and a mirrored surface facing the mirror housing. The vehicular external mirror module also includes a luminescent film fixedly secured to the mirror surface of the mirror glass. The luminescent film emits light out from the luminescent film through the mirror glass.

The present invention relates to a vehicle external mirror module having a mirror glass assembly, the latter having at least one mirror glass and at least one luminescent element attached thereto.

An external mirror of this type is known from DE 103 27 072. A heating film is situated behind the mirror glass, which projects beyond the meandering heating element laid thereon. LEDs, whose light exits in front of the front side of the mirror glass, are attached to the projecting part of the film, which is additionally guided around the edge of the mirror glass.

The present invention is thus based on the object of developing a vehicle external mirror module, in which at least one luminescent element is integrated in a space-saving way and is attached in such way that it may be mounted easily and securely with little wiring outlay.

This object is achieved by the features of the main claim. For this purpose, at least one of the luminescent elements is a luminescent film. The luminescent film(s) is/are situated behind the mirror glass. The mirroring of the mirror glass is partially transparent or semitransparent in at least some areas in the area of the luminescent films.

The luminescent elements incorporated in the external mirror module are typically electroluminescent films. The luminescent elements, for example, have their wiring integrated in the heating film in addition to the heating element. The heating film equipped in this way is then united with the mirror glass and a mirror glass support to form a mirror glass assembly through gluing, for example.

The luminescent element is mounted together with the mirror heater in a simple way by inserting and gluing the heating film, which is usually thin. Since the heater and the luminescent element have a shared terminal strip or a shared plug, for example, the connection of the external mirror module to the vehicle is additionally simplified.

In addition to the luminescent films, other luminescent elements, such as LEDs, are possibly also situated on the heating film. These diodes are seated on the edge of the mirror glass in front of the mirroring, for example.

Further details of the present invention result from the subclaims and the following description of multiple exemplary embodiments, which are schematically illustrated.

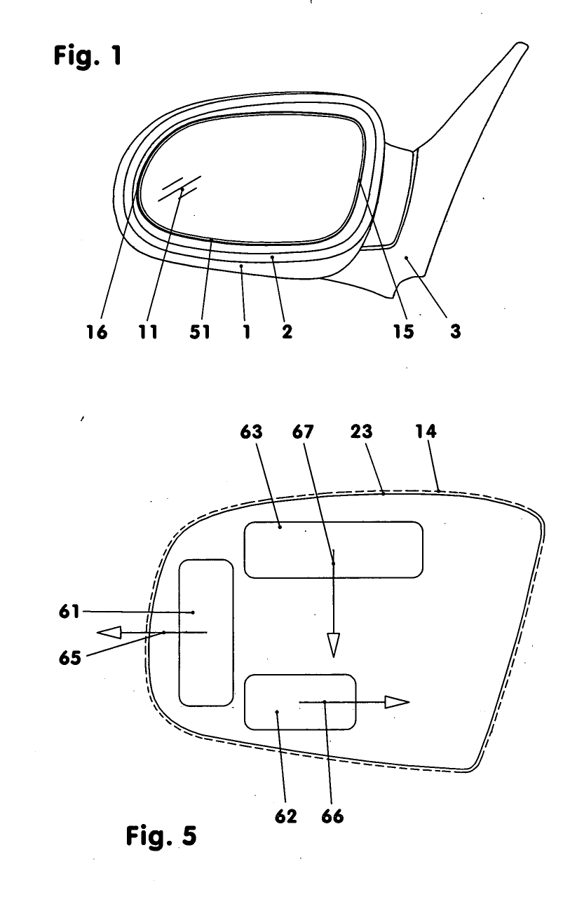

FIG. 1: shows a vehicle external mirror module viewed from the mirror side;

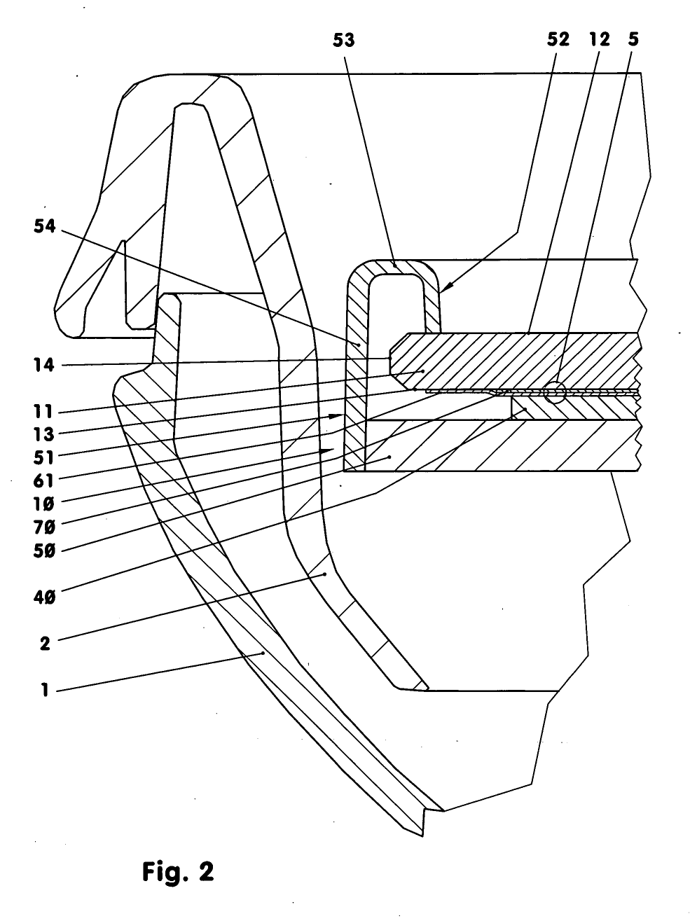

FIG. 2: shows a partial section through the vehicle external mirror module having luminescent film and transmitted light orientation film;

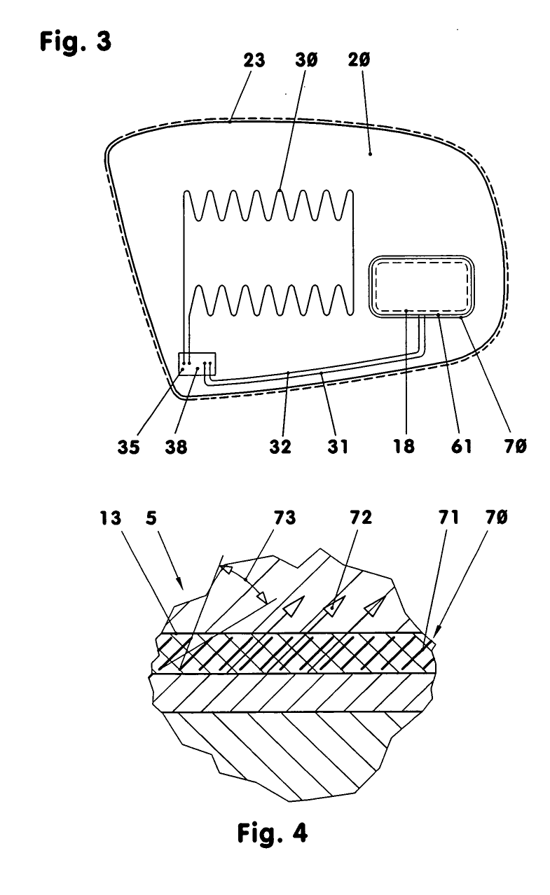

FIG. 3: shows a heating film having an integrated luminescent film;

FIG. 4: shows a partial section having a transmitted light orientation film;

FIG. 5: shows an arrangement plan for multiple luminescent films.

FIG. 1 shows a vehicle external mirror module which, inter alia, comprises a mirror housing (1), a mirror glass (11), and a mirror base cover (3) of a mirror base (not shown).

A partial section oriented transversely to the mirror glass (11) is shown in FIG. 2. A mirror glass module (10) is enclosed here laterally and on the back by the mirror housing (1) and the enclosure (2), which is engaged or glued therewith. The mirror glass module (10) is typically mounted so it is adjustable in the housing (1). For this purpose, this mirror glass module (10) is seated with play inside the enclosure (2).

As shown in FIG. 2, the mirror glass module (10) comprises a mirror glass support (50), an adhesive film (40), a heating film (20) having integrated luminescent film (61-63), and a mirror glass frame (51). The mirror glass (11) is attached to the mirror glass support (50) using an adhesive film (40) and a heating or combination film (20), which is also adhesive. The adhesive film (40) is, for example, a microcellular rubber or another thin-walled elastomer body equipped on both sides with an adhesive layer. During the mounting, the adhesive layer of the combination film (20) is glued onto the back (13) of the mirror glass (11). The adhesive film (40) is applied in turn to the combination film (20), in order to thus bond the mirror glass (11) to the mirror glass support (50). The mirror glass frame (51) encloses the mirror glass support (50) to mechanically secure the mirror glass (11) on the mirror glass support (50), inter alia. For this purpose, the frame (51) has an outer edge section (54), which presses against the outer contour of the mirror glass support (50) and projects beyond the mirror glass exterior (12) toward the front. The outer edge section (54) encloses an angle less than or equal to 90° with the mirror glass exterior (12). A few millimeters in front of the mirror glass exterior (12), the frame (51) passes into a section (53) which is oriented parallel to the mirror glass exterior (12). This section (53) passes into an inner edge section (52) which comes to rest on the mirror glass exterior (12) at approximately 90°.

The mirror glass frame (51) and the mirror glass support (50) are permanently welded or glued to one another, for example.

FIG. 3 shows a combination film (20) having a heating web (30), an integrated luminescent film (61), a transmitted light orientation film (70), two printed conductors (31, 32), and a connection plug (35). The combination film (20) has a wall thickness of approximately 0.3 to 0.5 mm. The film thickness is predefined for this purpose by the luminescent film component.

The luminescent film (61) is an electroluminescent film in a flexible or rigid embodiment, which is equipped at least toward the mirror glass (11) with a self-adhesive layer as a part of the heating film (20), for example. In the area in which the luminescent film (61) is positioned, the mirroring is semitransparent, i.e., it allows the cold light generated behind the back (13) of the mirror glass (11) in the luminescent film (61) to shine through nearly unobstructed, while the transparency resulting due to the semitransparency is not perceived by the driver looking into the rearview mirror. This applies at least for the operating state in which the luminescent film (61) is not powered. The area of the semitransparent window (18) of the mirroring is smaller than the light-emitting area of the luminescent film (61). The edge of the light-emitting area is behind the completely mirrored area of the mirror.

The light color of the particular luminescent film (61-63) may be tailored to the intended purpose.

A transmitted light orientation film (70) is situated between the luminescent film (61) and the mirror glass (11) in the exemplary embodiment shown in FIGS. 2 and 3. This film, whose area is also larger than the light-emitting area of the luminescent film (61), is a transparent plastic film whose thickness is less than 1 mm, cf. FIG. 4. Microlamellae (71), which are oriented parallel to one another, are situated in the film. The microlamellae (71) have a wall thickness which is in the range of a hundredth of a millimeter, for example. Their distance to one another is 10 times higher, for example. The microlamellae (71) enclose an angle of 60° with the face of the mirror back (13), for example. Accordingly, the primary light exit direction corresponds to the direction of the arrows (72).

Depending on the intended use, the angle may be in a range from 30 to 90°. This angle of individual lamellae areas to one another may vary within a transmitted light directional opening. The opening angle (73) between two neighboring microlamellae (71) is typically 30 to 40°.

FIG. 5 shows the front of a combination film (20) having multiple integrated luminescent film areas (61-63), without heating web, printed conductors, and connection plug. The luminescent film (61) is used here as a signal light for indicating a change of travel direction. A transmitted light orientation film is placed in front of it, whose microlamellae are oriented from top to bottom. The microlamellae enclose an angle of 20 to 80° with the mirror glass surface (12)—measured in a plane parallel to the roadway surface. A light direction (65) which is primarily oriented to the rear and also to the side facing away from the vehicle, for example, results through this orientation, cf. FIG. 5. As a result, the signal light is well visible to traffic located to the rear and traveling past. The driver cannot perceive the signaling because of the microlamellae orientation.

In addition to the rectangular luminescent film (61), for example, a luminescent film (62) provided as an indicator light is also located on the bottom. Its light direction (66) is oriented toward the driver. For this purpose, the transmitted light orientation film in front of it has a small lamellar angle of approximately 30 to 40° in relation to the mirror glass surface. The traffic to the rear does not perceive the light of the indicator lights. By using the microlamellae, the indicator light may still be perceived well even in bright sunlight. Via the indicator light, which, for example, comprises multiple differently shaped and separately activatable luminescent film areas—in the form of symbols or writing—information of the electronic lane change system and/or the blind spot monitor may be communicated to the driver.

A luminescent film (63), which fulfills the function of a background light, is situated in the upper mirror area. It makes getting in and out of the vehicle easier in the dark, for example, in that it illuminates the roadway surface next to the driver and/or passenger doors. The light direction (67) is directed downward for this purpose. As a result, the traffic to the rear is not disturbed.

In the exemplary embodiment, the heating web (30), shown in FIG. 3, has two meandering sections in the middle area of the mirror. It (30) ends on the mirror back in the left, lower area in the connection plug (35). Instead of a connection plug (35), the printed conductors (31, 32) and the heating web (30) may also end in individual contact tabs, to which power is then supplied in the vehicle external mirror module via springy contact bridges if necessary.

The printed conductors (31, 32) run largely parallel to the edge (23) of the combination film (20). They are applied here on the side of the combination film (20) on which the heating web (30) is situated. Of course, there is also the possibility of attaching the individual printed conductors and heating web in different, electrically insulated levels of a multilayered combination or heating film (20).

In addition, ballasts for the light elements or parts of the electronic controller of the mirror adjusting drives may be situated on the combination film (20), e.g., in edge areas. If necessary, the combination film may be reinforced in some areas to receive discrete electronic components, such as ICs.

Notwithstanding the exemplary embodiments, the luminescent film (61) may also be attached separately to the mirror back (13) together with the printed conductors (31, 32)—which are possibly also applied to a film. This is the case when the external mirror is not heated, for example.

### LIST OF REFERENCE NUMBERS

1 mirror housing, vehicle external mirror housing
2 enclosure
3 mirror base cover
5 cutout
10 mirror glass assembly
11 mirror glass
12 mirror glass exterior, non-mirrored
13 mirror glass exterior, mirrored
14 mirror edge
15 mirror edge area facing toward the driver
16 mirror edge area facing away from the driver
18 mirror area, semitransparent; window
20 heating film, combination film
23 heating film edge
30 heating web, heating element
31, 32 printed conductors
35 connection plug, power terminal
38 power terminal
40 adhesive film
50 mirror glass support
51 mirror glass frame
52 inner edge section
53 section parallel to the mirror glass exterior
54 outer edge section
61 luminescent element, luminescent film
62 luminescent element, luminescent film
63 luminescent element, luminescent film
65 light direction
66 light direction
67 light direction
70 transmitted light orientation film
71 microlamellae
72 light direction, arrows
73 light angle

1-4. (canceled)

5. A vehicular external mirror module comprising:
a mirror housing;
a mirror glass housed within said mirror housing, said mirror glass including a non-mirrored surface facing out of said mirror housing and a mirrored surface facing into said mirror housing; and
a luminescent film fixedly secured to said mirror surface of said mirror glass for emitting light out from said luminescent film through said mirror glass.

6. A vehicular external mirror module as set forth in claim 5 including a transmitted light orientation film disposed between said mirror glass and said luminescent film to direct the light emitted by said luminescent film.

7. A vehicular external mirror module as set forth in claim 6 wherein a portion of said mirrored surface is partially transparent.

8. A vehicular external mirror module as set forth in claim 7 wherein said luminescent film and said transmitted light orientation film are disposed adjacent said portion of said mirrored surface that is partially transparent.

9. A vehicular external mirror module as set forth in claim 8 wherein said luminescent film is substantially planar.

10. A vehicular external mirror module as set forth in claim 9 wherein said transmitted light orientation film is substantially planar.

11. A vehicular external mirror module as set forth in claim 10 wherein said transmitted light orientation film includes a plurality of microlamellae to direct the light emitted by said luminescent film.

12. A vehicular external mirror module as set forth in claim 11 wherein each of said plurality of microlamellae are parallel to each other.

13. A vehicular external mirror module as set forth in claim 12 wherein each of said plurality of microlamellae defines a thickness of approximately one hundredth of a millimeter.
